(19) United States
(12) Patent Application Publication
(10) Pub. No.: US 2005/0111900 A1
(43) Pub. Date: May 26, 2005

(54) Ampoule and method of use

(76) Inventors: Francesca Fazzolari, Hackettstown, NJ (US); David G. Robinson, Newton, NJ (US); Richard J. May, Saylorsburg, PA (US); Carol Bottiglierie, Hackettstown, NJ (US); Alexander T. Davidson, Sparta, NJ (US); Ronald M. Douros, Wantage, NJ (US); Carol Gamsby, Milford, PA (US); Henry E. Kowalla, Columbia, NJ (US); Mari Mulitsch, Pen Argyl, PA (US)

Correspondence Address: PAUL J. NYKAZA, ESQ.;WALLENSTEIN WAGNER & ROCKEY, LTD., 53RD FLOOR, 311 SOUTH WACKER DRIVE, CHICAGO, IL, 60606-6630, US

(21) Appl. No.: 10/999,893

(22) Filed: Nov. 30, 2004

(51) Int. Cl. B43K 5/14; B67D 5/52

(52) U.S. Cl. 401/132

(57) ABSTRACT

A dispenser (10) for dispensing a flowable material is disclosed. The dispenser (10) comprises a first rupturable container (20) containing the flowable material, and a second container (40) having an applicator (80). The first container (20) is housed within the second container (40). The flowable material is adapted to be dispensed from the second container (40) by the applicator (80).

### TECHNICAL FIELD

The invention generally relates to a dispenser for a flowable substance, or glass ampoule, and in particular, the invention relates to a fluid dispenser having a rupturable container.

### BACKGROUND OF THE INVENTION

Ampoules are well known in the art, particularly ampoules made from glass. Ampoules are generally used to contain and dispense a flowable material once the ampoule is activated. Traditionally, however, ampoules were available in a few limited configurations and have been used only in a relatively narrow variety of uses.

While ampoules according to the prior art provide a number of advantageous features, they nevertheless have certain limitations. The present invention seeks to overcome certain of these limitations and other drawbacks of the prior art, and to provide new features and new uses for ampoules not heretofore available.

### SUMMARY OF THE INVENTION

The present invention provides a dispenser for dispensing a flowable material which is preferably a fluid. The dispenser comprises a first rupturable container housed within a resilient second container. In accordance with the invention, the first container includes a sealed first chamber which contains the flowable material to be dispensed. The second container contains the first container. The second container has a closed first end and an open second end. The open second end of the second container receives an applicator for dispensing the flowable material.

According to one aspect of the invention, the second container includes a second chamber which houses the entire first container therein.

According to another aspect of the invention, the applicator is a cotton swab which is friction fit inside the open second end of the second container. In this way, the applicator serves as a stop to prevent the first container from exiting the second chamber of the second container.

According to yet another aspect of the invention, the dispenser includes a sleeve which is cooperatively dimensioned with the second container. The sleeve includes at least one indicator which serves to identify the location at which force should be applied to activate the dispenser. The sleeve alternatively serves as a cover to the second container.

According to yet another aspect of the invention, the dispenser is used to contain and dispense a large variety of fluids, including adhesives, medicinal products, hygiene products, paint, etc.

### BRIEF DESCRIPTION OF THE DRAWINGS

FIG. 1 IS A PERSPECTIVE VIEW OF A DISPENSER ACCORDING TO THE PRESENT INVENTION;

FIG. 2 IS AN EXPLODED PERSPECTIVE VIEW OF THE DISPENSER OF FIG. 1;

FIG. 3 is a side view of the dispenser of FIG. 1 showing a user applying force to rupture the dispenser;

FIG. 4 is a cross-sectional view of the dispenser taken along lines 4-4 of FIG. 1; and

FIG. 5 is a perspective view of the dispenser of FIG. 1 shown in use by an operator.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

As seen in FIGS. 1-5, the present invention relates to a dispenser generally designated by the reference numeral 10. The dispenser 10 generally comprises a first container 20 disposed within a second container 40, a cover, or sleeve 60, and an applicator 80. As shown in FIG. 1, the dispenser 10 has an elongated axis A-A along its length. In one preferred embodiment, the dispenser 10 is generally cylindrical, however, it is understood that the dispenser 10 can take on a variety of other shapes. The dispenser 10 may sometimes be referred to as a swab.

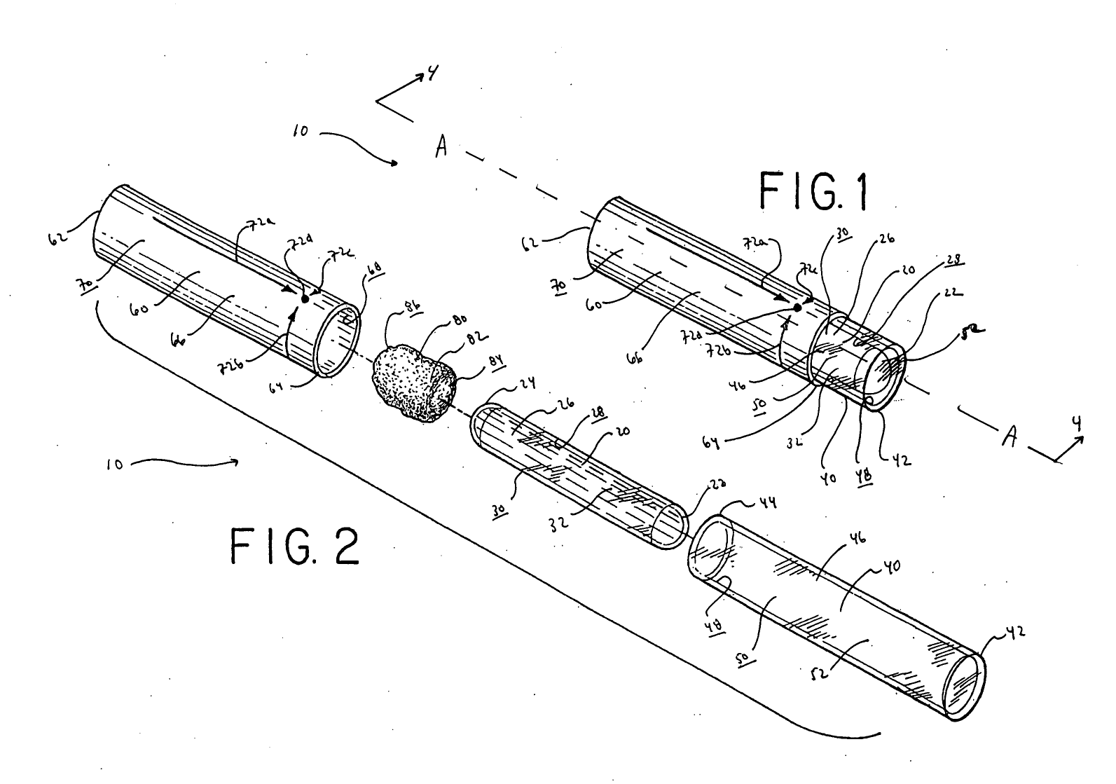

Referring now to FIG. 2, the first container 20 has a first end 22, a second end 24, and a peripheral wall 26. The container 20 additionally has an interior surface 28, and an exterior surface 30. The first container 20 has a generally cylindrical shape, and is closed at both the first and second ends 22,24. In this way, the container 20 is adapted to receive and contain a flowable material. Preferably the flowable material is a fluid, however, the dispenser 10 can also be configured to dispense flowable solids, such as powders. The interior surface 28 of the first container 20, along with the closed first and second ends 22, 24 cooperate to define a first chamber 32 in the first container 20. The first chamber 32 receives and contains the flowable material to be dispensed by the dispenser 10. The first container 20 is preferably made of a rigid fracturable material, and most preferably is made of glass. The first container 20 has a cross-section perpendicular to the axis A-A of the dispenser 10. Preferably the cross-section of the first container 20 is circular.

Turning to FIGS. 2 and 4, the second container 40 also has a first end 42, a second end 44, and a peripheral wall 46. The second container 40 has an interior surface 48, and an exterior surface 50. In the preferred embodiment of the dispenser 10, the first end 42 of the second container 40 is closed while the second end 44 of the second container 40 is open. This allows the second container 40 to receive either end 22, 24 of the first container 20 within it. The interior surface 48 of the second container 40, along with the closed first end 42 cooperate to define a second chamber 52 within the second container 40. The second chamber 52 receives at least a portion of the first container 20. The interior surface 48 of the second container 40 is cooperatively dimensioned with the exterior surface 30 of the first container 20 such that the second container 40 fits snugly over the first container 20, as seen in FIG. 4. The second container 40 is preferably made of a flexible resilient material, and most preferably is made of plastic. In the most preferred embodiment, the second container 40 is made of transparent or translucent plastic, such that materials within the second container 40 are visible. However, the second container 40 may also be opaque, for example, in situations where the flowable material or other contents are light sensitive. The second chamber 60 also has a cross-section which is perpendicular to the axis A-A of the dispenser 10. Preferably, the cross-section of the second container 40 is circular.

The dispenser 10 also comprises a cover, or sleeve 60, best seen in FIG. 2. The sleeve 60 has a first end 62, a second end 64, and a peripheral wall 66. The sleeve 60 also has an interior surface 68 and an exterior surface 70. Preferably, the first end 62 of the sleeve 60 is closed, while the second end 64 of the sleeve 60 is open to receive the remainder of the dispenser 10 including the first and second containers 20,40. However, it is understood that the sleeve could be open on both ends 62,64. The interior surface 68 of the sleeve 60 is cooperatively dimensioned with the exterior surface 50 of the second container 40, such that the sleeve 60 fits snugly over the second container 40, as seen in FIGS. 1 and 4. The sleeve 60 can also include a series of exterior indicators 72a,b,c,d on the exterior surface 70 of the sleeve 60. These indicators 72a,b,c,d serve to locate the preferred location at which pressure or force should be applied to rupture, or activate, the dispenser 10, as will be discussed further herein. The sleeve 60 is preferably made of a flexible resilient material, and most preferably is made of paper or cardboard, upon which the indicators 72a,b,c,d can be easily placed. The sleeve 60 can also receive various other markings, such as instructions for use, or branding marks.

Finally, the dispenser 10 includes an applicator 80. The applicator 80 is located at the second end 44 of the second container 40, which is the open end. The applicator 80 is preferably a cotton swab 82, as seen in FIGS. 1-5, however, a large variety of different applicators 80 could be used without departing from the spirit of the present invention. For example, the applicator 80 could be a dropper, a nozzle, or a foam pad or other absorbent materials, all well known in the art. All that is important is that the applicator 80 be located proximate the open second end 44 of the second container 40 where it can receive the flowable material to be dispensed when the dispenser 10 is activated. The swab 82 includes an interior surface 84 and an exterior surface 86. The interior surface 84 faces generally towards the second chamber 52, while the exterior face 86 faces generally away from the second chamber 52.

It should be noted that although the embodiments depicted in the FIGS. and described herein include a single first container 20 within the second container 40, it is understood that a dispenser 10 may include two or more first containers 20 located within the second container 40 while remaining within the scope and spirit of the present invention. Each of the plurality of first containers 20 would preferably be made of a rigid fracturable material, and most preferably made of glass. Each of the plurality of first containers 20 would function in a way substantially similar to that otherwise described herein.

The following description is directed towards the fabrication and operation of the dispenser 10. In order to be operational, the first chamber 32 of the first container 20 is filled with a flowable material, such as a fluid. Once filled and sealed, the first chamber 32 acts as a capsule to contain the flowable material within the first container 20. The filled first container 20 is then inserted into the second chamber 52, inside the second container 40, as seen in FIG. 2. Specifically, the first end 22 of the first container 20 is inserted through the open second end 44 of the second container 40 such that the first container 20 enters the second chamber 52 of the second container 40. Most preferably, the first container 20 is inserted such that it is entirely within the second chamber 52 of the second container 40, as seen in FIGS. 4 and 5.

Following the insertion of the first container 20, the applicator 80 is connected to the open end 44 of the second container 40, and in this way acts as a cap for the second container 40. More specifically, the applicator 80, which is preferably friction fit into the open second end 44 of the second container 40, acts to prevent the first container 20 from being removed from inside the second chamber 52 in the second container 40. Although in a preferred embodiment the applicator 80 is friction fit into the second container 40 such that the applicator 80 fits snugly against the inside surface 48 of the peripheral wall 46, the applicator 80 can be connected to the second end 44 of the second container 40 in a variety of ways well known in the art. For example, the applicator 80 can be screwed on to mating threads located on the second container 40, can be connected with an adhesive, or can be held in place with a fastener. Additionally, the applicator 80 may be solvent sealed, chemically bonded, or ultraviolet or radio frequency bonded to the second container 40.

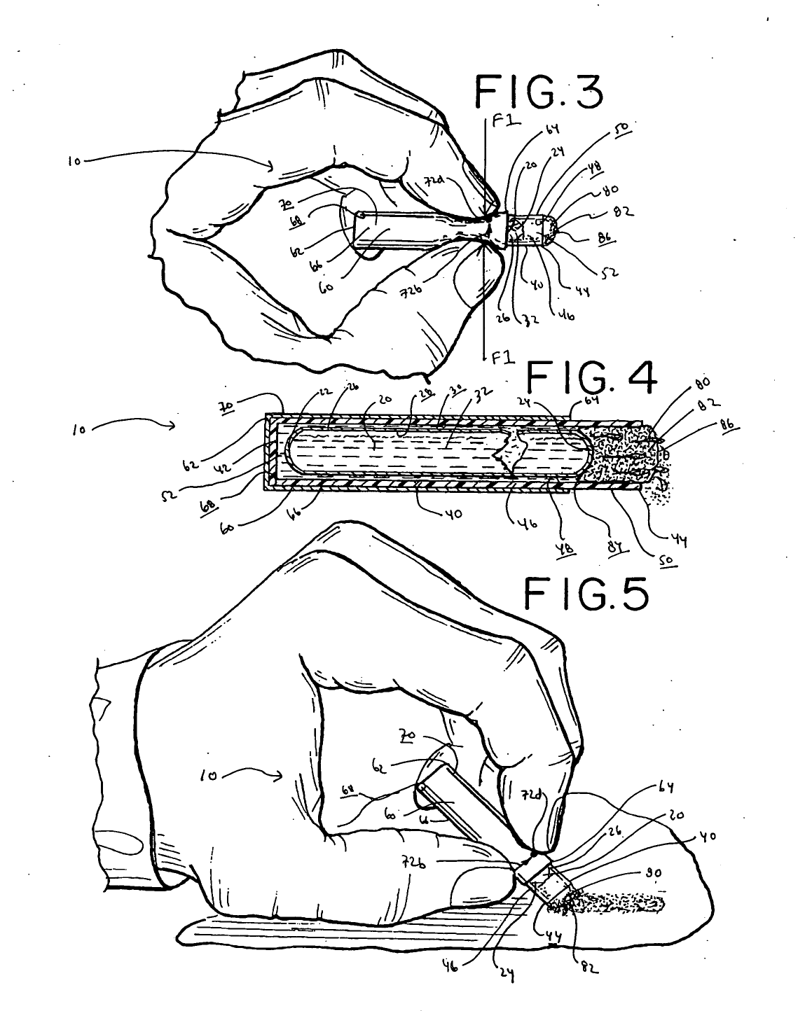

Once the second container 40 has been capped by the installation of the applicator 80, the second container 40 is inserted into the sleeve 60, as seen in FIGS. 1-2. Specifically, the second container 40 is inserted into the open second end 64 of the sleeve 60. In this position, the applicator 80 is inserted into the sleeve 60 until it is adjacent the closed first end 62 of the sleeve 60, such that it is covered or capped by the first end 62. In this position, the dispenser 10 is in the closed position, as seen in FIG. 1. Dispensers 10 are preferably packaged and shipped in this configuration. It should also be recognized that the sleeve 60 acts as a cover when placed over the second end 44 of the second container 40, where it can serve to cover and protect the applicator 80 until such time that the dispenser 10 is to be used. Furthermore, it should be noted that the sleeve 60 is altogether optional, and that the dispenser 10 can be operated without the use of a sleeve 60. The sleeve 60 serves the optional purposes of covering and protecting the dispenser 10, and providing indicators 72a,b,c,d as to where force should be applied to rupture the first container 20, and activate the dispenser 10, when the dispenser 10 is in the open position (FIG. 3).

The dispenser 10 is typically distributed in an original or closed position, best seen in FIG. 1. In order to be used, the dispenser 10 must first be placed in the open position, depicted in FIGS. 3-5. Essentially, the open position (FIGS. 3-5) differs from the closed position (FIG. 1) in that the sleeve 60 is placed on the opposite end 42,44 of the second container 40. Therefore, to move the dispenser 10 from the closed position to the open position, the sleeve 60 must be removed from the second container 40. Specifically, the sleeve 60 is slidably extracted from the second container 40 until the second end 44 of the second container 40 exits the sleeve 60, such that the applicator 80 is exposed. The sleeve 60 is then placed over the first end 42 of the second container 40 and the second container 40 is inserted into the sleeve 60 until the first end 42 of the second container 40 is adjacent to the closed first end 62 of the sleeve 60. Although it is preferable that after rupturing of the first chamber 20, as described herein, the sleeve 60 be moved from the second end 44 of the second chamber 40 to the first end 42 of the second chamber 40 where it is used as a grip, it should also be recognized that the sleeve 60 may alternatively be removed from the second end 44 of the second container 40 and discarded. Stated differently, the sleeve 60 is not necessary. Therefore, a user may place the sleeve 60 in the open position, to provide an improved grip on the second chamber 40, as seen in FIG. 5, or may alternatively discard the sleeve 60, and simply grasp the second container 40 directly when using the dispenser 10.

In the open position (FIGS. 3-5), the dispenser 10 is able to apply the flowable material to a surface, as seen in FIG. 5. However, it is necessary that the dispenser 10 be activated, as depicted in FIG. 3. Activation of the dispenser 10 requires application of a squeezing force F1, as seen in FIG. 3. Preferably, the squeezing force is applied to the dispenser 10 at the location of the indicators 72a,b,c,d. However, all that is required is that the squeezing force F1 be placed on the preferable surface 50 of the second container 40. The squeezing force F1 compresses the sleeve 60, the second container 40, and the first container 20. Because the sleeve 60 and second container 40 are resilient, they flex against the force F1. However, the rigid first container 20 fractionates or ruptures under the force F1 causing the flowable material to escape from the first chamber 32 of the first container 20. The flowable material escaping from the first chamber 32 flows into the second chamber 52, where it contacts the applicator 80 at the second end 44 of the second container 40. After the first chamber 20 has been ruptured, or fractionated, the dispenser 10 is ready to be used to apply, or dispense, the first flowable material.

When the flowable material escapes from the first chamber 32 through the ruptured peripheral wall 26 of the first container 20, the material flows into the second chamber 52 located in the second container 40. The flowable material in the second chamber 52 is absorbed by the applicator 80, preferably a cotton swab 82. Through wicking action, which is well known in the art, the flowable material is transported from the interior surface 84 of the swab 82 to the exterior surface 86 of the swab 82. The saturated exterior surface 86 of the swab 82 can then be dabbed or touched to a surface, as seen in FIG. 5, for application and dispensing of the flowable material. As can be seen, once the first container 20 has been fractionated or ruptured, the flowable material is free to flow, and cannot be recaptured within the first chamber 32. For example, in one preferred embodiment, the dispenser 10 may contain an acne medication in the form of a medicated fluid. Such acne medications are known in the art and while particular medications may have distinct components, the medications are typically in the form of a flowable substance. Once the dispenser 10 is activated as explained above, the dispenser 10, and in particular the applicator 80, can be pressed against a user's skin to apply the acne medication.

The fractionated rigid first container 20 is retained in the second chamber 52 by the applicator 80, which is specifically designed to allow the passage of the flowable material, but not other solids (such as portions of the first container 20). In this way, the applicator 80 acts as a filter. Moreover, the resilient second container 40 protects the user's fingers from injury by the fractionated pieces of the first container 20 which remain in the second chamber 52. In this way, the dispenser 10 permits the flowable material to be dispensed without contamination from, or injury by broken pieces of the first container 20. Furthermore, the sleeve 60, can be removed from the first end 42 of the second container 40, and replaced over the second end 44 of the second container 40, following the use of the dispenser 10. By returning the sleeve 60 to its original position such that the dispenser 10 is in the closed position, the sleeve 60 acts as a cover to prevent further dispensing of the flowable material from the second chamber 52 through the applicator 80.

The dispenser 10 is designed to primarily contain and dispense flowable materials that are fluids. This permits the dispenser 10 to be used in a wide variety of uses, and contain and dispense a large variety of fluids. For example, the dispenser 10 can dispense a flowable material or mixture that is an adhesive, epoxy, or sealant, such as an epoxy adhesive, craft glue, super glue, leak sealant, shoe glue, ceramic epoxy, fish tank sealant, formica repair glue, tire repair patch adhesive, nut/bolt locker, screw tightener/gap filler, super glue remover or goo-b-gone. Also, the dispenser 10 can dispense a flowable material or mixture that is an automotive product, such as a rear view mirror repair kit, a vinyl repair kit, an auto paint touch up kit, a window replacement kit, a scent or air freshener, a windshield wiper blade cleaner, a lock de-icer, a lock lubricant, a liquid car wax, a rubbing compound, a paint scratch remover, a glass/mirror scratch remover, radiator stop-leak, or a penetrating oil. The dispenser 10 can also dispense a flowable material or mixture that is a chemistry material, such as a laboratory chemical, a fish tank treatment, a plant food, a cat litter deodorant, a buffer solution, a rehydration solution, a biological stain, or a rooting hormone.

Moreover, the dispenser 10 can dispense a flowable material or mixture that is a cosmetic, fragrance or toiletry, such as nail polish, lip gloss, body cream, body gel, hand sanitizer, cologne, perfume, nail polish remover, liquid soaps, skin moisturizers, tooth whiteners, hotel samples, mineral oils, toothpastes, or mouthwash. The dispenser 10 can also dispense a flowable material or mixture that is an electronics product, such as a cleaning compound, a telephone receiver sanitizer, a keyboard cleaner, a cassette recorder cleaner, a mouse cleaner, or a liquid electrical tape. In addition, the dispenser 10 can dispense a flowable material or mixture that is a food product, such as food colorings, coffee flavorings, spices, food additives, drink additives, confections, cake gel, sprinkles, breath drops, condiments, sauces, liquors, alcohol mixes, or energy drinks. The dispenser 10 can also dispense a flowable material or mixture that is a hair care product, such as hair bleaches, hair streaking agent, hair highlighter, shampoos, hair colorants, conditioners, hair gels, mousse, hair removers, or eyebrow dye. The dispenser 10 can also dispense a flowable material that is a home repair product, such as a caulk, a scratch touch up kit, a stain remover, a furniture repair product, a wood glue, a patch lock, screw anchor, wood tone putty or porcelain touch-up.

In addition, the dispenser 10 can dispense a flowable material or mixture that is a test kit, such as a lead test kit, a drug kit, a radon test kit, a narcotic test kit, a swimming pool test kit, a home water quality tester, a soil test kit or a gas leak detection fluid. The dispenser 10 can dispense a large variety of lubricants including industrial lubricants, oils, greases, graphite lubricant's or a dielectric grease. The dispenser 10 can also dispense a flowable material or mixture that as part of a medical device test kit, such as a culture media, a drug monitoring system, a microbiological reagent, a streptococcus test kit, or a residual disinfectant tester. In addition, the dispenser 10 can dispense a large variety of medicinal products, such as blister medicines, cold sore treatments, insect sting and bit relief products, skin cleaning compounds, tissue markers, topical antimicrobials, topical demulcent, treatments for acne such as acne medications, umbilical area antiseptics, cough medicines, waterless hand sanitizers, and toothache remedies. Furthermore, the dispenser 10 can dispense a flowable material or mixture that is a novelty product, such as a chemiluminescent light, a Christmas tree scent, a glitter gel, a face paint, novelty paints, paint additives, wood stain samples, caulk, paint mask fluid or paint remover. The dispenser 10 can also dispense a flowable material or mixture that is a personal care product, such as shaving cream or gel, aftershave lotion, skin conditioner, skin cream, skin moisturizer, petroleum jelly, insect repellant, personal lubricant, ear drops, eye drops, nose drops, corn medications, nail fungal medication, aging liquids, acne cream, contact lens cleaner, denture repair kit, finger nail repair kit, liquid soaps, sun screen, lip balm, tanning cream, or self-tanning solutions. A large variety of pest control products can be dispensed by the dispenser 10, including insect attractants, pesticides, pet medications, pet insect repellants, pet shampoos, pest sterilizers, lady bug attractant, fly trap attractant. Various safety products can be dispensed through the dispenser 10 including respirator tests and eye wash solution.

The dispenser 10 can also dispense a large variety of stationery or craft products, such as magic markers, glitter gels, glitter markers, glitter glues, gel markers, craft clues, fabric dyes, fabric paints, permanent markers, dry erase markers, dry eraser cleaner, glue sticks, rubber cement, typographic correction fluids, ink dispensers and refills, paint pens, counterfeit bill detection pen, envelope squeeze moisturizers, adhesive label removers, highlighters, and ink jet printer refills. The dispenser 10 can also dispense various vitamins, minerals, supplements and pet vitamins. The dispenser 10 can also dispense a flowable material or mixture for aroma therapy products, breathalyzer tests, wildlife lures, eyeglass cleaners, portable lighting fuels, bingo and other game markers, float and sinker devices, toilet dyes and treatments, dye markers, microbiological reagents, shoe polishes, clothing stain removers, carpet cleaners and spot removers, tent repair kits, plumbing flux applicator, rust remover, tree wound treatment, animal medicine dispenser, animal measured food dispenser, odor eliminator liquids, and multi-purpose oils. In addition, the dispenser 10 can be used as, or in connection with a suction device for culture sampling, taking various liquid samples, taking various swabbing samples and for acting as a chemical tester, such as may be used for testing drinks for various “date rape” drugs. In addition, the dispenser 10 can dispense a variety of sports products including sports eye black, football hand glue, and baseball glove conditioner. The dispenser 10 can dispense any variety of flowable materials including liquids and powders, and further including a liquid and a powder, two or more powders, or two or more liquids. The dispenser 10 may be used as part of 2-part system (mix before use) including a liquid with a powder, a liquid with a liquid, a powder with a powder, or sealed inside another tube or product container or partially sealed, connected or attached to another container. The dispenser 10 may also be used as part of a plunger dispensing system.

The dispenser 10 of the present invention may also be used for windshield wiper blade cleaner and other automotive applications, fragrances, pastry gels, eyebrow dye, paints, hair paints, finger nail repair kit, animal medicine dispenser, animal food dispenser, culture media samples, drug test kits, and chemical testers (e.g. date rape etc.).

While the invention has been described in its preferred embodiments, it is to be understood that the words which have been used are words of description rather than limitation and that changes may be made within the purview of the appended claims without departing from the true scope and spirit of the invention in its broader aspects. As an illustration, although the applicator has been described as being utilized for mechanical uses, it can similarly be used for applying adhesives, mastic or the like.

1. A dispenser for dispensing a flowable material comprising:
a first rupturable container containing the flowable material in the form of an acne medication; and
a second container having an applicator, wherein the first container is housed within the second container, and the flowable material is adapted to be dispensed from the second container by the applicator.

2. The dispenser of claim 1 wherein the first container is glass.

3. The dispenser of claim 1 wherein the second container is made of resilient plastic.

4. The dispenser of claim 1 wherein the applicator is a swab.

5. The dispenser of claim 1 further comprising a sleeve covering a portion of the second container.

6. The dispenser of claim 5 wherein the sleeve has at least one indicator indicating the location where force is to be applied to the second container.

7. The dispenser of claim 1 wherein the applicator is a dropper.

8. The dispenser of claim 1 wherein the applicator is a nozzle.

9. The dispenser of claim 1 wherein the applicator is a foam pad.

10. A method of dispensing a flowable material comprising the steps of:
providing a dispenser comprising a first rupturable container and a second container, wherein the second container has an applicator, wherein the first container is housed within the second container;
filling the first container with a flowable material in the form of an acne medication;
applying a force to the second container to rupture the first container housed therein; and
flowing the flowable material out of the first container and into the second container where the flowable material is absorbed by the applicator.

11. The method of claim 10 further comprising the step of contacting the applicator to a surface upon which the flowable material is to be dispensed.

12. The method of claim 10 wherein the flowable material is an adhesive.

13. The method of claim 10 wherein the flowable material is a medicinal product.

14. The method of claim 10 wherein the flowable material is a fluid.

15. The method of claim 10 wherein the flowable material is paint.

16. The method of claim 10 wherein the flowable material is a lubricant.
